(19) United States
(12) Patent Application Publication
(10) Pub. No.: US 2018/0154401 A1
(43) Pub. Date: Jun. 7, 2018

(54) HAIR DUSTER ASSEMBLY WITH DISPOSABLE AND REUSABLE DUSTER INSERTS

(71) Applicant: Shannon Lewis, Manhattan, KS (US)

(72) Inventor: Shannon Lewis, Manhattan, KS (US)

(21) Appl. No.: 15/369,784

(22) Filed: Dec. 5, 2016

(51) Int. Cl. B08B 1/00; B25G 3/34

(52) U.S. Cl. CPC B08B 1/006; B25G 3/34

(57) ABSTRACT

A hair duster assembly for a barber includes a multipurpose handle, a disposable duster insert, and a reusable duster insert. The disposable and reusable duster inserts can be alternately mounted in respective first and second bore segments at opposite ends of the handle to provide both disposable and reusable duster capabilities for the barber. An intermediate bore segment extends between the first and second bore segments to facilitate assembly of the duster inserts to the handle. The first and second bore segments have different diameters to accommodate different dimensions of the disposable and reusable duster inserts. The duster inserts are formed by folding a paper towel or cloth material to have a first portion folded into a fan shape and a second portion folded over the fan shape to provide a covering wrap. A flexible tie member secures a proximal end of the duster insert together in its folded configuration.

### BACKGROUND OF THE INVENTION

### Field of the Invention

The present invention relates generally to hair dusters for use by barbers and cosmetologists, and in particular, to a hair duster assembly with a handle that can be used with multiple duster inserts.

### Description of the Related Art

Barbers and cosmetologists are both professions that cut, style and wash hair, among other things. Hair dusters are commonly used by both barbers and cosmetologists to whisk cut hair from a customer's face, neck and shoulders following a haircut. The term “barber” in this application will be understood to include both barbers and cosmetologists.

Permanent hair dusting brushes, also known as “neck dusters,” with soft bristles have been customarily used by barbers. However, modern sanitary regulations for barbers often prohibit the use of such dusting brushes because they are considered unsanitary.

Hand towels are sometimes used to wipe cut hair from a customer's face and neck following a haircut. Such towels must be either disposed or laundered after each use to comply with sanitary regulations.

There is a need for an economical device that functions as a neck duster while complying with sanitary regulations that prevent permanent hair dusting brushes.

### SUMMARY OF THE INVENTION

An object of the present invention is to provide a sanitary hair duster that can be used effectively to whisk hair from a person's face, neck and shoulders following a haircut by a barber or cosmetologist.

A further object of the present invention is to provide a hair duster that can be quickly and efficiently changed from using a disposable duster insert to a reusable duster insert, while allowing the same handle to be used with either type of duster insert.

A further object of the present invention is to provide a hair duster insert having a disposable cloth material or reusable fabric material with a special folded configuration for stiffness and increased surface area for dusting.

To accomplish these and other objects, the present invention provides a hair duster assembly for a barber that includes a multipurpose handle, a disposable duster insert, and a reusable duster insert. The disposable and reusable duster inserts can be alternately mounted in respective first and second bore segments at opposite ends of the handle to provide both disposable and reusable duster capabilities for the barber. An intermediate bore segment extends between the first and second bore segments to facilitate assembly of the duster inserts to the handle. The first and second bore segments have different diameters to accommodate different dimensions of the disposable and reusable duster inserts. The duster inserts are formed by folding a paper towel or cloth material to have a first portion folded into a fan shape and a second portion folded over the fan shape to provide a covering wrap. A flexible tie member secures a proximal end of the duster insert together in its folded configuration.

According to one aspect of the present invention, a hair duster assembly is provided, comprising: a multipurpose handle having first and second ends and an outer surface for gripping in a user's hand, a first bore segment extending from the first end toward the second end, a second bore segment extending from the second end toward the first end, and an intermediate bore segment extending between the first and second bore segments; a disposable duster insert that can be removably mounted within the first bore segment of the handle, the disposable duster insert having a proximal end with an outer dimension that fits within the first bore segment and abuts against a first inner shoulder of the handle between the first bore segment and the intermediate bore segment; and a reusable duster insert that can be removably mounted within the second bore segment of the handle, the reusable duster insert having a proximal end with an outer dimension that fits within the second bore segment and abuts against a second inner shoulder of the handle between the second bore segment and the intermediate bore segment. The disposable duster insert and the reusable duster insert can be alternately mounted in respective opposite ends of the handle to provide both disposable and reusable duster capabilities for a barber.

According to another aspect of the present invention, a hair duster assembly is provided, comprising: a handle having first and second ends and an outer surface for gripping in a user's hand, a first bore segment extending from the first end toward the second end; and a duster insert removably mounted within the first bore segment of the handle, the duster insert having a proximal end with an outer dimension that fits within the first bore segment and abuts against an inner shoulder of the handle. The duster insert comprises a flexible material having a folded configuration with a first portion folded into a fan shape and a second portion folded over the fan shape to provide a covering wrap that stiffens the flexible material and provides increased surface area for dusting.

Numerous other objects of the present invention will be apparent to those skilled in this art from the following description wherein there is shown and described embodiments of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a perspective view of a multipurpose handle for a hair duster assembly according to the present invention.

FIG. 2 is another perspective view showing an opposite end of the handle of FIG. 1.

FIG. 3 is a side view of the handle.

FIG. 4 is an end view showing the first end of the handle.

FIG. 5 is another end view showing the second end of the handle.

FIG. 6 is a cross section view of the handle.

FIG. 7 is a cross section view of the hair duster assembly with a disposable duster insert positioned in the first end of the handle.

FIG. 8 is a cross section view of the hair duster assembly with a reusable duster insert positioned in the second end of the handle.

FIG. 9 is a cross section end view showing a proximal end portion of the disposable duster insert positioned within a bore segment of the handle.

FIG. 10 is an end view of the hair duster assembly with the reusable duster insert positioned in the handle.

FIG. 11 is a partial cross section view of the reusable duster insert showing the proximal end portion secured together in its folded configuration by a flexible tie member.

### DETAILED DESCRIPTION OF THE INVENTION

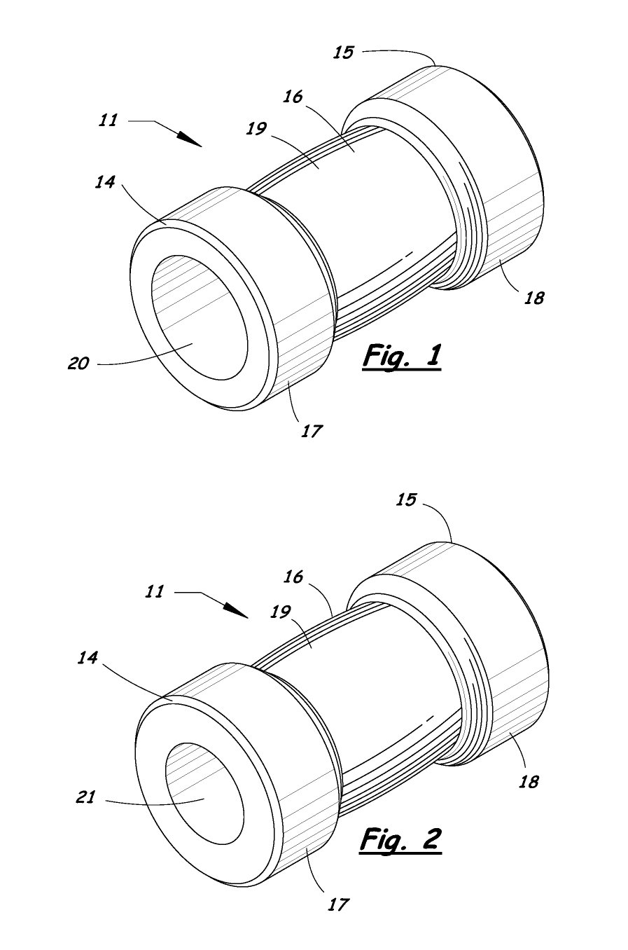

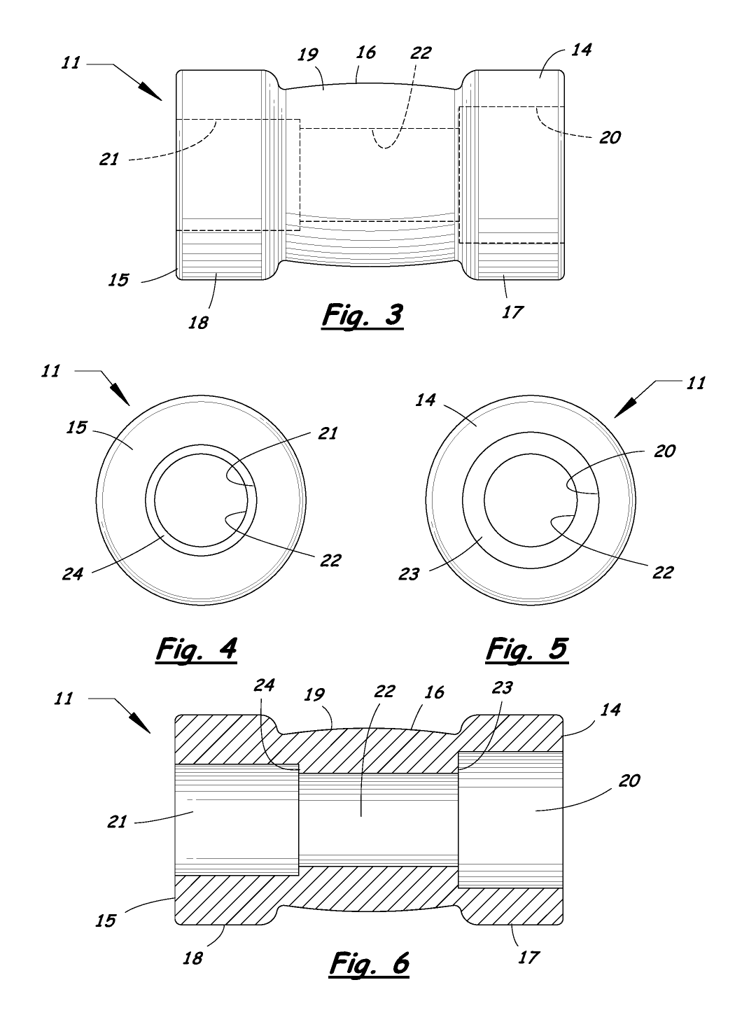

A hair duster assembly 10 according to the present invention will now be described with reference to FIGS. 1 to 11 of the accompanying drawings.

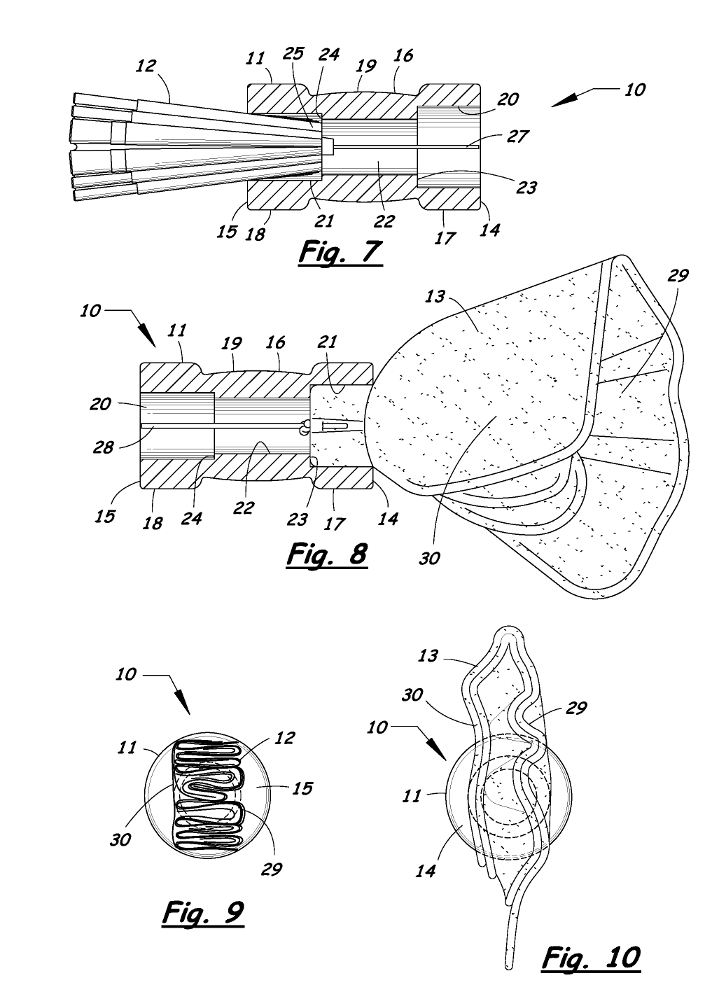

The hair duster assembly 10 includes a multi-use handle 11, a disposable duster insert 12, and a reusable duster insert 13. The handle 11 is illustrated in FIGS. 1 to 6. The handle 11 in combination with the duster inserts 12, 13 is illustrated in FIGS. 7 to 10.

The handle 11 has first and second ends 14, 15 and an outer surface 16 for gripping in a user's hand. The outer surface 16 has first and second end portions 17, 18 and an intermediate portion 19 between the first and second end portions 17, 18. The intermediate portion 19 has a smaller diameter than the first and second end portions 17, 18 to facilitate handling. In the illustrated embodiment, the outer surface 16 of the handle 11 has a round profile that can be made, for example, by turning a workpiece on a lathe.

The handle 11 has a first bore segment 20 extending from the first end 14 toward the second end 15, and a second bore segment 21 extending from the second end 15 toward the first end 14. An intermediate bore segment 22 extends between the first and second bore segments 20, 21. The first and second bore segments 20, 21 each have a larger diameter than the intermediate bore segment 22. The first bore segment 20 has a larger diameter than the second bore segment 21. The first and second bore segments 20, 21 and the intermediate bore segment 22 are coaxial in the illustrated embodiment.

A first inner shoulder 23 is formed at the interface between the first bore segment 20 and the intermediate bore segment 22. A second inner shoulder 24 is formed at the interface between the second bore segment 21 and the intermediate bore segment 22.

FIG. 7 shows the disposable duster insert 12 mounted in the second bore segment 21 of the handle 11, and FIG. 8 shows the reusable duster insert 13 mounted in the first bore segment 20 of the handle 11. The proximal end 25 of the disposable duster insert 12 has an outer dimension that fits within the second bore segment 21 and abuts against the second inner shoulder 24 in the handle 11 when fully inserted into the second bore segment 21. The proximal end 26 of the reusable duster insert 13 has an outer dimension that fits within the first bore segment 21 and abuts against the first inner shoulder 23 in the handle 11 when fully inserted into the first bore segment 20. The outer dimensions of the proximal ends 25, 26 of the duster inserts 12, 13 are larger than the diameter of the intermediate bore segment 22 to prevent the duster inserts 12, 13 from passing through the intermediate bore segment 22.

The outer dimension of the proximal end 26 of the reusable duster insert 13 is larger than the outer dimension of the proximal end 25 of the disposable duster insert 12. The handle 11 accommodates the different sizes by having the first bore segment 20 formed with a larger diameter than the second bore segment 21.

The reusable duster insert 13 and the disposable duster insert 12 can be alternately mounted in the respective opposite first and second ends 14, 15 of the handle 11 to provide both reusable and disposable duster capabilities and options for a barber.

The disposable duster insert 12 is made of a paper towel material, which is inexpensive, biodegradable, and intended to be disposed of following a single use. The reusable duster insert 13 is made of a cloth material, which can be laundered and reused multiple times. By providing both disposable duster inserts 12 and reusable duster inserts 13, the barber will be able to use the duster assembly 10 in a wide variety of applications while staying in compliance with applicable sanitary guidelines and regulations.

The paper towel material is secured together in its folded configuration at the proximal end 25 thereof by a flexible tie member 27. For example, the flexible tie member 27 can be a zip tie that passes through a hole in the proximal end 25 of the disposable duster insert 12 and is fastened shut to secure the proximal end 25 of the disposable duster insert 12 together in the folded configuration. When assembled to the handle 11, the flexible tie member 27 extends through the intermediate bore segment 22 and can be grabbed by a user to facilitate assembly of the disposable duster insert 12 to the handle 11.

The cloth material of the reusable duster insert 13 is secured together in its folded configuration at the proximal end 26 thereof by a flexible tie member 28. For example, the flexible tie member 28 can be a zip tie that passes through a hole in the proximal end 26 of the reusable duster insert 13 and is fastened shut to secure the proximal end 26 of the reusable duster insert 13 together in the folded configuration. When assembled to the handle 11, the flexible tie member 28 extends through the intermediate bore segment 22 and can be grabbed by a user to facilitate assembly of the reusable duster insert 13 to the handle 11.

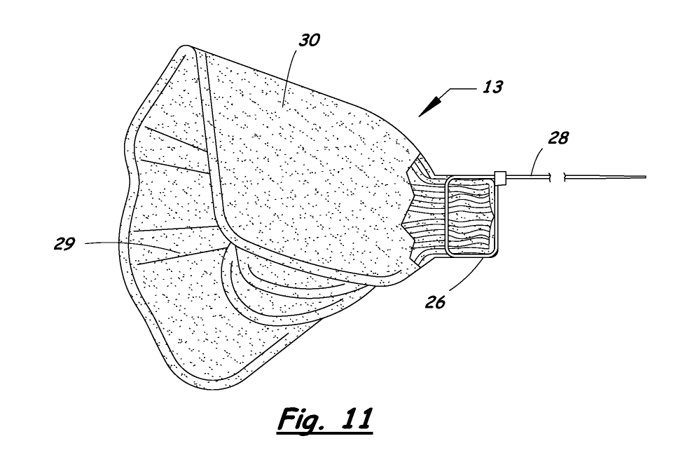

The paper towel material and cloth material of the duster inserts 12, 13 have a modified folded fan shape, as illustrated in FIGS. 7 to 11. The modified folded fan shape is provided by folding a first portion 29 of the material into a fan shape with a series of long, narrow accordion-style folds, with the bottom and top of each fold aligned with the last fold, as illustrated in the end view of FIG. 9 for the disposable duster insert 12, and as illustrated in FIGS. 10 and 11 for the reusable duster insert 13. A second portion 30 of the material is then folded over the fan shape to provide a covering wrap over one side of the fan shape. The covering wrap provided by the second portion 30 stiffens the duster inserts 12, 13 and provides increased surface area for more effective dusting. The paper towel material and cloth material of the duster inserts 12, 13 can also be folded over to create a double ply thickness before the first portion 29 is folded into a fan shape and the second portion 30 is folded into a covering wrap.

While the invention has been described in connection with specific embodiments thereof, it is to be understood that this is by way of illustration and not of limitation, and the scope of the appended claims should be construed as broadly as the prior art will permit.

What is claimed is:

1. A hair duster assembly for a barber, comprising:
a multi-use handle having first and second ends and an outer surface for gripping in a user's hand, a first bore segment extending from said first end toward said second end, a second bore segment extending from said second end toward said first end, and an intermediate bore segment extending between said first and second bore segments;
a disposable duster insert that can be removably mounted within the first bore segment of said handle, said disposable duster insert having a proximal end with an outer dimension that fits within the first bore segment and abuts against a first inner shoulder of said handle between said first bore segment and said intermediate bore segment;
a reusable duster insert that can be removably mounted within the second bore segment of said handle, said reusable duster insert having a proximal end with an outer dimension that fits within the second bore segment and abuts against a second inner shoulder of said handle between said second bore segment and said intermediate bore segment;
whereby said disposable duster insert and said reusable duster insert can be alternately mounted in respective opposite ends of said handle to provide both disposable and reusable duster capabilities for a barber.

2. The hair duster assembly according to claim 1, wherein said outer surface of said handle has first and second end portions and an intermediate portion between said first and second end portions, said intermediate portion having a smaller diameter than said first and second end portions to facilitate handling.

3. The hair duster assembly according to claim 1, wherein said first and second bore segments each have a larger diameter than said intermediate bore segment.

4. The hair duster assembly according to claim 3, wherein said first bore segment, said second bore segment, and said intermediate bore segment are coaxial.

5. The hair duster assembly according to claim 3, wherein said first bore segment has a different diameter than said second bore segment.

6. The hair duster assembly according to claim 1, wherein the outer dimension of the proximal end of the reusable duster insert is larger than the outer dimension of the proximal end of the disposable duster insert, and said second bore segment has a larger diameter than said first bore segment to accommodate the larger outer dimension of said reusable duster insert.

7. The hair duster assembly according to claim 1, wherein said disposable duster insert comprises a paper towel material having a folded configuration secured together at the proximal end thereof.

8. The hair duster assembly according to claim 7, wherein said paper towel material comprises a first portion folded into a fan shape with a series of accordion-style folds, and a second portion folded over said fan shape to provide a covering wrap that stiffens said disposable duster insert and provides increased surface area for dusting.

9. The hair duster assembly according to claim 7, wherein the proximal end of said disposable duster insert is secured together by a flexible tie member.

10. The hair duster assembly according to claim 9, wherein said flexible tie member extends through said intermediate bore to facilitate assembly of the disposable duster insert to the handle.

11. The hair duster assembly according to claim 9, wherein said flexible tie member is a zip tie that passes through a hole in said proximal end of said disposable duster insert and is fastened shut to secure said proximal end of said disposable duster insert together in said folded configuration.

12. The hair duster assembly according to claim 1, wherein said disposable duster insert has an outer dimension that allows the disposable duster insert to be inserted into the first bore of the handle but not passed through the intermediate bore of the handle.

13. The hair duster assembly according to claim 1, wherein said reusable duster insert comprises a cloth material having a folded configuration secured together at the proximal end thereof.

14. The hair duster assembly according to claim 13, wherein said cloth material comprises a first portion folded into a fan shape with a series of accordion-style folds, and a second portion folded over said fan shape to provide a covering wrap that stiffens said reusable duster insert and provides increased surface area for dusting.

15. The hair duster assembly according to claim 13, wherein the proximal end of said reusable duster insert is secured together by a flexible tie member.

16. The hair duster assembly according to claim 15, wherein said flexible tie member extends through said intermediate bore to facilitate assembly of the reusable duster insert to the handle.

17. The hair duster assembly according to claim 15, wherein said flexible tie member is a zip tie that passes through a hole in said proximal end of said reusable duster insert and is fastened shut to secure said proximal end of said reusable duster insert together in said folded configuration.

18. The hair duster assembly according to claim 1, wherein said reusable duster insert has an outer dimension that allows the reusable duster insert to be inserted into the second bore of the handle but not passed through the intermediate bore of the handle.

19. A hair duster assembly for a barber, comprising:
a handle having first and second ends and an outer surface for gripping in a user's hand, a first bore segment extending from said first end toward said second end; and
a duster insert removably mounted within the first bore segment of said handle, said duster insert having a proximal end with an outer dimension that fits within the first bore segment and abuts against an inner shoulder of said handle;
said duster insert comprising a flexible material having a folded configuration with a first portion folded into a fan shape and a second portion folded over said fan shape to provide a covering wrap that stiffens said flexible material and provides increased surface area for dusting.

20. The hair duster assembly according to claim 19, wherein the proximal end of said duster insert is secured together by a flexible tie member.

21. The hair duster assembly according to claim 20, wherein said flexible tie member is a zip tie that passes through a hole in said proximal end of said duster insert and is fastened shut to secure said proximal end of said duster insert together in said folded configuration.
